(19) United States
(12) Patent Application Publication
(10) Pub. No.: US 2010/0221636 A1
(43) Pub. Date: Sep. 2, 2010

(54) FUEL CELL AND METHOD FOR PRODUCTION THEREOF

(75) Inventors: Michael-Carsten Oszcipok, Freiburg (DE); Steffen Eccarius, Freiburg (DE)

Correspondence Address: SCHWEGMAN, LUNDBERG & WOESSNER, P.A., P.O. BOX 2938, MINNEAPOLIS, MN, 55402, US

(73) Assignee: Fraunhofer-Gesellschaft zur Forderung der Angewandten Forschung E.V., Munchen (DE)

(21) Appl. No.: 12/532,418

(22) PCT Filed: Mar. 20, 2008
(86) PCT No.: PCT/EP08/02269

§ 371 Date: Mar. 26, 2010

(30) Foreign Application Priority Data
Mar. 23, 2007 (DE) 10 2007 014 046.2

(51) Int. Cl. H01M 8/10; H01M 4/88

(52) U.S. Cl. 429/480; 429/483; 427/115

(57) ABSTRACT

The invention relates to a fuel cell which has a membrane-electrode unit comprising an ion-conducting membrane with catalyst layers which are disposed on oppositely situated surfaces of the membrane and serve as anode and cathode, and also possibly an anode-side and/or a cathode-side gas diffusion layer, the membrane-electrode unit having adjacent regions with different diffusion transport for educts and/or products. The invention likewise relates to a method for the production of fuel cells of this type.

The invention relates to a fuel cell which has a membrane-electrode unit comprising an ion-conducting membrane with catalyst layers which are disposed on oppositely situated surfaces of the membrane and serve as anode and cathode, and also possibly an anode-side and/or a cathode-side gas diffusion layer, the membrane-electrode unit having adjacent regions with different diffusion transport for educts and/or products. The invention likewise relates to a method for the production of fuel cells of this type.

Fuel cells convert chemical energy directly into electrical energy. For this purpose, reactands are supplied continuously in gaseous or in liquid form to the fuel cells. The electrochemical conversion is made possible with the help of a physical separation of the reducing or oxidising species, for example by an ion exchanger membrane which is coated on both sides with catalyst, the so-called electrodes.

In addition to the desired transport of ions, the result in real operation is the undesired, diffusion-controlled transport of reactands and water through the membrane. As a result, many undesired accompanying phenomena can occur, such as e.g. drying out of the membrane or undesired subsidiary reactions at the electrodes. A further undesired effect is based on the electroosmotic transport of water or liquid fuel together with the ions through the membrane. Due to physical laws, these effects are always connected to each other. The proportions of the individual effects thereby vary according to the operating point. The operating point of a fuel cell system must often be chosen such that a tolerable ratio is produced between the different connected transport mechanisms in order to enable a stable long-term operation. However, it can thereby occur that the system cannot be operated at the most efficient or productive operating point.

In the case of some fuels, e.g. alcohols or chemical hydrides, water is required for oxidation of the fuel. On the basis of the above-described transport mechanisms, the mixture remains directly on the catalyst but not in the desired constant ratio, but instead changes. This can cause mass transport restraints and consequently efficiency losses in the fuel cell.

In the state of the art, decoupling of the transport phenomena of electroosmotic reactand- and ion transport is sought after for example by introducing particles or intermediate layers into the membrane.

Starting herefrom, it was the object of the present invention to provide a fuel cell which avoids the above-described problems with respect to the transport processes in the fuel cells. Hereby, it is intended to refer in particular to systems which are easily operated and can be produced easily.

This object is achieved by the fuel cell having the features of claim 1 and the method having the features of claim 28 or 29. The further dependent claims reveal advantageous developments.

According to the invention, a fuel cell is provided, which has a membrane-electrode unit made of an ion-conducting membrane with catalyst layers which are disposed on oppositely situated surfaces of the membrane and serve as anode and cathode. Furthermore, the fuel cell possibly contains an anode-side and/or a cathode-side gas diffusion layer. The membrane-electrode unit thereby has adjacent regions with different diffusion transport for educts and/or products. This is achieved in that, in the regions with low diffusion transport, at least one of the catalyst layers represents or has a higher diffusion barrier than the catalyst layer in the regions with higher diffusion transport.

The invention hence describes passive decoupling of the transport phenomena by graduation of the electrodes. Regions which permit exclusively or at least increased diffusive material transport are produced within the electrodes. As a result of the fact that these regions are in the direct vicinity of zones in which also the electroosmotic exchange can take place, the operation of the fuel cells is optimised passively because, by means of a developing microcirculation within the membrane, the latter is kept by educts or products at optimum moisture. This microcirculation can be assisted by compete removal of the catalyst layer at selected places on the electrode. Even thinning of the catalyst layer can in fact be adequate since the catalyst layer represents a diffusion resistance for the water or the fuel. By reducing the catalyst layer thickness or complete removal, this resistance can be reduced.

By means of the graduated electrodes, optimum operating conditions can be achieved with passive methods, as a result of which no parasitic energy investments are required. As a result, complicated water recirculation systems or gas/gas wetting apparatus can be dispensed with. The technical processing complexity is therefore considerably reduced and, associated therewith, the costs are lowered and the system stability is increased. In addition, the invention is suitable in particular for passive, electrochemical cells in which little or indeed no energy is available for operating peripheral components.

A preferred embodiment provides that, in the regions with higher diffusion transport of the fuel cell, at least one of the catalyst layers has an at least reduced layer thickness relative to the layer thicknesses of the catalyst layers in regions with lower diffusion transport of the fuel cell. A further preferred variant provides that, in the regions with higher diffusion transport, at least one of the catalyst layers is completely removed so that a diffusion barrier which is reduced relative to the other regions is present here.

A further preferred variant provides that at least one gas diffusion layer, in the regions with higher diffusion transport relative to the regions with lower diffusion transport, has higher hydrophobicity. In the regions of higher hydrophobicity, the water concentration thereby rises, as a result of which the diffusion through the membrane increases in these regions.

A further preferred embodiment provides that the diffusion barrier is chosen such that, in the regions with higher diffusion transport, the transport processes of the educts and/or products through the membrane are determined essentially by diffusion transport and not by electroosmotic transport. The diffusion barrier is preferably chosen such that, between the regions with higher diffusion transport and the regions with lower diffusion transport, a microcirculation is produced for the transport of educts and/or products.

The diffusion properties are preferably coordinated to water as product in a fuel cell, e.g. a DMFC.

With respect to the size of the regions with lower diffusion transport or with higher diffusion transport, basically no restrictions exist.

Preferably, the size of the regions with lower diffusion transport is in the range of 100 nm² to 10 mm². This applies to regions with a higher diffusion transport. With respect to the geometry of these regions, absolutely no restrictions exist, bar-shaped, round or square shapes are preferred here.

A preferred embodiment provides that the fuel cell is a hydrogen-polymer-electrolyte-membrane-fuel cell (PEMFC). The diffusion barrier is preferably hereby chosen such that the diffusive back transport of water outweighs the electroosmotic transport of water in the fuel cell. In this case, the supply of water on the anode side can preferably be dispensed with.

A second preferred embodiment provides that the fuel cell is a direct oxidation fuel cell, in particular a direct alcohol fuel cell. The diffusion barrier is hereby chosen preferably such that the diffusive transport of water from the oxidising to the reducing electrode outweighs the electroosmotic transport of water from the cathode to the anode.

The membrane of the membrane-electrode unit preferably comprises a polymer. This is selected preferably from the group consisting of perfluorinated polymers containing sulphone groups (SPE), e.g. Nafion, polybenzimidazole (PBI), polyetheretherketone (PEEK), sulphonated polyetheretherketone (sPEEK) and blends and copolymers thereof.

Furthermore, it is preferred that the membrane is proton-conducting. This relates to the current variants of known fuel cells.

The membrane can thereby be constructed both homogeneously and non-homogeneously. In a further preferred variant, the membrane can have in addition functionally coated particles for controlling the diffusion- and/or electroosmotic transport.

The catalyst layers contained in the fuel cell preferably comprise platinum, ruthenium, iron, nickel, cobalt and/or alloys or mixtures thereof or consist of these.

A further preferred embodiment provides that the fuel cell has in addition at least one fluid distribution structure and at least one device for removing gaseous components of the liquid fuel. The degasification device can thereby be present in the form of microstructuring of the fluid distribution structure which assists the transport of gaseous media away from the fluid distribution structure. For this purpose, it is possible for example that the fluid distribution structure has at least one channel with a T-shaped cross-section.

Another possibility for degassing provides that the fuel cell has, on the anode side, at least one barrier layer which is permeable for gases and impermeable for liquids, as a result of which the liquids can be retained in the fluid distribution structure and the gases can be transported away from the fluid distribution structure to the reaction zone.

In the last mentioned case, the barrier layer preferably involves an oleophobised membrane, a nanofiltration membrane, e.g. a porous membrane, a pervaporation membrane, e.g. a PDMS membrane, or a ceramic.

According to the invention, a method for the production of a fuel cell, as was described previously, is likewise provided, in which the membrane is coated on at least one surface with a catalyst layer and the regions with higher diffusion transport are produced by reducing or complete removal of the layer thickness of the catalyst layer in these regions by means of laser irradiation.

Another variant for the production of a fuel cell, as was described previously, is based on the fact that the membrane of the fuel cell is provided on at least one surface by means of screen printing, spraying, knife-coating, tampon printing or decal methods in regions with a catalyst layer.

The subject according to the invention is intended to be explained in more detail with reference to the subsequent examples, without wishing to restrict said subject to the special embodiments shown here.

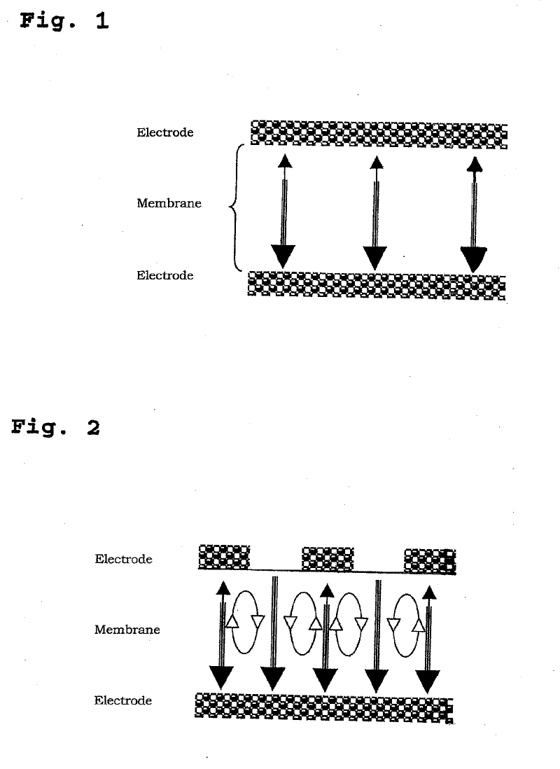

FIG. 1 shows the transport processes in a conventional fuel cell known from the state of the art, with reference to a schematic representation. The smaller arrow hereby represents the ion transport and the electroosmotic water transport, whilst the larger arrow represents the diffusion-driven water transport.

In FIG. 2, the transport processes for a fuel cell according to the invention are represented schematically. Regions can be detected here which are defined solely by the diffusion-driven water transport whilst, in the other regions, the conventional transport processes, i.e. both the electroosmotic and the diffusion-driven water-transport, are present. Between the regions, the result is formation of microcirculations for water which are represented schematically by the circular paths.

### EXAMPLE 1

### Hydrogen-/Air-Operated Membrane Fuel Cells

Different moisture contents can result within one cell. In the air inlet region, the membrane can be for example too dry, in the outlet region too wet. The membrane becomes too dry because water is transported electroosmotically with the protons from the hydrogen side to the air side and the diffusive back transport of the product water becomes predominant (see FIG. 1).

At such places, diffusion paths for the water are produced by the invention, which diffusion paths are not subject to the electroosmotic transport and therefore are decoupled therefrom. As a result, a water circulation on a microscale can consequently be formed, which leads to homogenisation of the water content in the membrane (see FIG. 2).

### EXAMPLE 2

### Methanol-/Air-Driven Membrane Fuel Cells

In the case of direct methanol fuel cells, water must also be present for the reaction in order to oxidise the methanol. This water is typically supplied with the methanol from a tank which contains a water-methanol mixture. However, the energy density of the fuel is significantly reduced as a result. By means of the graduation, according to the invention, of the electrodes, product water can diffuse to the methanol side in a decoupled manner in order to be available as reaction partner. On the cathode of a direct methanol fuel cell, more water is produced than consumed on the anode. In this respect, the concentration gradient drives a water flow to the anode, counter to the electroosmotic force. By means of partial or complete graduation of the catalyst layer, the water back transport can be increased. As a result, the concentration of the methanol store can be increased up to 100%, as a result of which the energy density increases by a multiple relative to typically used low percentage mixtures. In an advantageous embodiment, only the cathode side is graduated. The water back transport offers additional advantages in the disposal of product water occurring on the cathode in the case of self-breathing cells with cathode structures which are open to the environment.

In a further advantageous embodiment, the anode of the direct methanol fuel cell is operated with a 100% solution of the fuel. The water required for oxidation of the fuel is added on the cathode side, contrary to conventional concepts, and diffuses using the graduation to the anode side and is available there as educt. A hydrophilic gas diffusion layer can assist wetting of the electrode with water and the transport of water via the cathode side to the anode, In the case of an additional storage of the cathode product water in for example capillary structures, a passive regulation of material concentrations can also be ensured during dynamic operating phases.

1. A fuel cell comprising a membrane-electrode unit comprising an ion-conducting membrane with catalyst layers which are respectively disposed on oppositely situated surfaces of the membrane and respectively serve as anode and cathode, the membrane-electrode unit comprising adjacent regions with different diffusion transport for educts and/or products, wherein in regions with lower diffusion transport, at least one of the catalyst layers has a higher diffusion barrier than catalyst layer in regions with higher diffusion transport.

2. The fuel cell according to claim 1, wherein, in the regions with higher diffusion transport, at least one of the catalyst layers has an at least reduced layer thickness relative to layer thicknesses of the catalyst layers in regions with lower diffusion transport.

3. The fuel cell according to claim 1, wherein, in the regions with higher diffusion transport, at least one of the catalyst layers is completely removed.

4. The fuel cell according to claim 1, comprising at least one anode-side and/or a cathode-side gas diffusion layer wherein the at least one gas diffusion layer, in the regions with higher diffusion transport relative to the regions with lower diffusion transport, has higher hydrophobicity.

5. The fuel cell according to claim 1, wherein the diffusion barrier is chosen such that, in regions with higher diffusion transport, the transport processes of the educts and/or products through the membrane are determined essentially by diffusion transport and not by electroosmosis.

6. The fuel cell according to claim 1, wherein the diffusion barrier is chosen such that, between regions with higher diffusion transport and regions with lower diffusion transport, a microcirculation is produced for the transport of educts and/or products.

7. The fuel cell according to claim 1, wherein the membrane-electrode unit has adjacent regions with different diffusion transport for water as product.

8. The fuel cell according to claim 1, wherein the size of the regions with lower diffusion transport is in the range of 100 nm² to 10 mm².

9. The fuel cell according to claim 1, wherein the regions with lower diffusion transport have a bar-shaped, round or square geometry.

10. The fuel cell according to claim 1, wherein the fuel cell is a hydrogen-polymer-electrolyte-membrane-fuel cell (PEMFC).

11. The fuel cell according to claim 1, wherein the diffusion barrier is chosen such that diffusive back transport of water outweighs electroosomotic transport of water.

12. The fuel cell according to claim 10, wherein the fuel cell has no supply for water on the anode side.

13. The fuel cell according to claim 1, wherein the fuel cell is a direct oxidation fuel cell, in particular a direct alcohol fuel cell.

14. The fuel cell according to claim 13, wherein the diffusion barrier is chosen such that diffusive transport of water from a reducing electrode to an oxidizing electrode outweighs electroosmotic transport of water from the oxidizing electrode to the reducing electrode.

15. The fuel cell according to claim 14, wherein the membrane comprises a polymer.

16. The fuel cell according to claim 15, wherein the polymer is selected from the group consisting of perfluorinated polymers with functional sulphone groups, polybenzimidazole (PBI), polyetheretherketone (PEEK), sulphonated polyetheretherketone (sPEEK) and blends and copolymers thereof.

17. The fuel cell according to claim 1, wherein the membrane is proton-conducting.

18. The fuel cell according to claim 1, wherein the membrane is anion-conducting.

19. The fuel cell according to claim 1, wherein the membrane is of homogeneous construction.

20. The fuel cell according to claim 1, constructed wherein the membrane is of nonhomogeneous construction.

21. The fuel cell according to claim 1, wherein the membrane has functionally coated particles for controlling the diffusion and/or electroosmotic transport.

22. The fuel cell according to claim 1, wherein at least one of the catalyst layers comprises at least one of platinum, ruthenium, iron, nickel, cobalt, tin and/or alloys or mixtures thereof.

23. The fuel cell according to claim 1, wherein the fuel cell comprises at least one fluid distribution structure and at least one degasification device for removing gaseous components of the liquid fuel.

24. The fuel cell according to claim 23, wherein the degasification device comprises a microstructuring of the fluid distribution structure which assists the transport of gaseous media away from the fluid distribution structure.

25. The fuel cell according to claim 24, wherein the fluid distribution structure has at least one channel with a T-shaped cross-section.

26. The fuel cell according to claim 1, wherein the fuel cell has, on the anode side, at least one barrier layer which is permeable for a gas and impermeable for a liquid, as a result of which the liquid is retained in the fluid distribution structure and the gas is transported away from the fluid distribution structure to the reaction zone.

27. The fuel cell according to claim 26, wherein the at least one barrier layer comprises at least one of an oleophobised membrane, a nanofiltration membrane, a porous nanofiltration membrane, a pervaporation membrane, a PDMS pervaporation membrane or a ceramic membrane.

28. A method for the production of a fuel cell comprising comprising a membrane-electrode unit comprising an ion-conducting membrane with catalyst layers which are respectively disposed on oppositely situated surfaces of the membrane and respectively serve as anode and cathode, the membrane-electrode unit comprising adjacent regions with different diffusion transport for educts and/or products, wherein in regions with lower diffusion transport, at least one of the catalyst layers has a higher diffusion barrier than a catalyst layer in regions with higher diffusion transport, wherein the method comprises providing the membrane on at least one surface by at least one of screen printing, spraying, knife-coating, tampon printing or decal methods in regions with a catalyst layer.

29. A method for the production of a fuel cell comprising comprising a membrane-electrode unit comprising an ion-conducting membrane with catalyst layers which are respectively disposed on oppositely situated surfaces of the membrane and respectively serve as anode and cathode, the membrane-electrode unit comprising adjacent regions with different diffusion transport for educts and/or products, wherein in regions with lower diffusion transport, at least one of the catalyst layers has a higher diffusion barrier than a catalyst layer in regions with higher diffusion transport, wherein the method comprises providing the membrane wherein the method comprises coating the membrane on at least one surface with a catalyst layer, and the regions with higher diffusion transport are produced by reducing or complete removal of the layer thickness of the catalyst layer in these regions by laser irradiation.
